(19) United States
(12) Patent Application Publication
(10) Pub. No.: US 2025/0363908 A1
(43) Pub. Date: Nov. 27, 2025

(54) QUESTION GENERATION APPARATUS, QUESTION GENERATION SYSTEM, AND QUESTION GENERATION METHOD

(71) Applicant: Hitachi, Ltd., Tokyo (JP)

(72) Inventors: Yawen XUE, Tokyo (JP); Yuta KOREEDA, Tokyo (JP); Masaya TSUNOKAKE, Tokyo (JP)

(21) Appl. No.: 19/068,421

(22) Filed: Mar. 3, 2025

(30) Foreign Application Priority Data
May 21, 2024 (JP) 2024-082795

(51) Int. Cl. G09B 7/06

(52) U.S. Cl. CPC G09B 7/06

(57) ABSTRACT

A question generation apparatus includes: an input unit that acquires context data including text information; a question generation unit that generates a first set of multiple-choice questions for the context data by processing the context data using a first large language model; an evaluation unit that determines difficulty level evaluation values indicating cognitive difficulty levels for the first set of multiple-choice questions by evaluating the first set of multiple-choice questions based on a predetermined cognitive difficulty level evaluation criterion; and a filtering unit that selects a first subset of multiple-choice questions of which the difficulty level evaluation values satisfy a predetermined cognitive difficulty level threshold from among the first set of multiple-choice questions, and outputs the selected first subset of multiple-choice questions.

### CROSS-REFERENCE TO RELATED APPLICATIONS

The present application claims priority to Japanese Patent Application No. 2024-082795, filed May 21, 2024. The contents of this application are incorporated herein by reference in their entirety.

### BACKGROUND OF THE INVENTION

### 1. Field of the Invention

The present disclosure relates to a question generation apparatus, a question generation system, and a question generation method.

### 2. Description of the Related Art

A multiple-choice question (MCQ) is an evaluation tool widely used in the field of education, and has also been used to quantify the performance of large language models (LLMs) in recent years.

The multiple-choice question usually includes explanatory text indicating a situation or a scenario in question, question text raising a question related to the explanatory text, a correct choice that is a correct answer to the question text, and distractors that indicate some wrong answers. It is expected that automating the creation of multiple-choice questions will significantly reduce the amount of manpower, time, cost, and effort required.

As a means for automating the creation of multiple-choice questions, for example, there is a study by Doughty et al. (Jacob Doughty, Zipiao Wan, Anishka Bompelli, Jubahed Qayum, Taozhi Wang, Juran Zhang, Yujia Zheng, Aidan Doyle, Pragnya Sridhar, Arav Agarwal, Christopher Bogart, Eric Keylor, Can Kultur, Jaromir Savelka, and Majd Sakr. 2024. A Comparative Study of AI-Generated (GPT-4) and Human-crafted MCQs in Programming Education. In Australian Computing Education Conference (ACE 2024), Jan. 29-Feb. 2, 2024, Sydney, NSW, Australia. ACM, New York, NY, USA 10 Pages. https://doi.org/10.1145/3636243.3636256).

Jacob Doughty, Zipiao Wan, Anishka Bompelli, Jubahed Qayum, Taozhi Wang, Juran Zhang, Yujia Zheng, Aidan Doyle, Pragnya Sridhar, Arav Agarwal, Christopher Bogart, Eric Keylor, Can Kultur, Jaromir Savelka, and Majd Sakr. 2024. A Comparative Study of AI-Generated (GPT-4) and Human-crafted MCQs in Programming Education. In Australian Computing Education Conference (ACE 2024), Jan. 29-Feb. 2, 2024, Sydney, NSW, Australia. ACM, New York, NY, USA 10 Pages. https://doi.org/10.1145/3636243.3636256 describes a “There is a constant need for educators to develop and maintain effective up-to-date assessments. While there is a growing body of research in computing education on utilizing large language models (LLMs) in generation and engagement with coding exercises, the use of LLMs for generating programming MCQs has not been extensively explored. We analyzed the capability of GPT-4 to produce multiple-choice questions (MCQs) aligned with specific learning objectives (LOs) from Python programming classes in higher education. Specifically, we developed an LLM-powered (GPT-4) system for generation of MCQs from high-level course context and module-level LOs. We evaluated 651 LLM-generated and 449 human-crafted MCQs aligned to 246 LOs from 6 Python courses. We found that GPT-4 was capable of producing MCQs with clear language, a single correct choice, and high-quality distractors. We also observed that the generated MCQs appeared to be well-aligned with the LOs. Our findings can be leveraged by educators wishing to take advantage of the state-of-the-art generative models to support MCQ authoring efforts.”

### SUMMARY OF THE INVENTION

In general, in order to accurately evaluate the understanding of learners, it is desirable to create not only low difficulty level questions that simply requires recollecting memorized knowledge but also high difficulty level multiple-choice questions that require deep understanding such as application of knowledge and analysis of certain concept.

A Comparative Study of AI-Generated (GPT-4) and Human-crafted MCQs in Programming Education describes a means for automatically generating programming multiple-choice questions using an LLM such as GPT-4. However, in the means described in A Comparative Study of AI-Generated (GPT-4) and Human-crafted MCQs in Programming Education, the multiple-choice questions are generated by a single-step procedure, and it has not been studied to control the cognitive difficulty levels of the multiple-choice questions according to the user's demand. For this reason, the multiple-choice questions generated by the technology according to A Comparative Study of AI-Generated (GPT-4) and Human-crafted MCQs in Programming Education may be low difficulty level questions such as so-called cloze tasks, making it difficult to accurately evaluate the understanding of the learners.

In addition, there is also a conventional proposal for evaluating the quality of multiple-choice questions based on, for example, difficulty of vocabulary or the number of choices, but this alone has limitations in accurately evaluating the cognitive ability required for answering the questions.

Therefore, an object of the present disclosure is to provide a question generation means capable of more accurately evaluating the understanding of learners and the performance of large language models by generating multiple-choice questions having a cognitive difficulty level according to a user's demand.

In order to solve the aforementioned problem, a representative question generation apparatus of the present invention includes a processor and a memory, in which the memory includes processing instructions for causing the processor to function as: an input unit that acquires context data including text information; a question generation unit that generates a first set of multiple-choice questions for the context data by processing the context data using a first large language model; an evaluation unit that determines difficulty level evaluation values indicating cognitive difficulty levels for the first set of multiple-choice questions by evaluating the first set of multiple-choice questions based on a predetermined cognitive difficulty level evaluation criterion; and a filtering unit that selects a first subset of multiple-choice questions of which the difficulty level evaluation values satisfy a predetermined cognitive difficulty level threshold from among the first set of multiple-choice questions, and outputs the selected first subset of multiple-choice questions.

According to the present disclosure, it is possible to provide a question generation means capable of more accurately evaluating the understanding of learners and the performance of large language models by generating multiple-choice questions having a cognitive difficulty level according to a user's demand.

Problems, configurations, and effects other than those described above will be apparent from the following description of embodiments for carrying out the invention.

### BRIEF DESCRIPTION OF THE DRAWINGS

FIG. 1 is a diagram illustrating a computer system for carrying out an embodiment of the present disclosure;

FIG. 2 is a diagram illustrating an example of a configuration of a question generation system according to an embodiment of the present disclosure;

FIG. 3 is a diagram illustrating a flow of data in a question generation apparatus according to an embodiment of the present disclosure;

FIG. 4 is a diagram illustrating processing performed by a summary generation unit according to an embodiment of the present disclosure;

FIG. 5 is a diagram illustrating processing performed by a question generation unit according to an embodiment of the present disclosure;

FIG. 6 is a diagram illustrating processing performed by an evaluation unit according to an embodiment of the present disclosure;

FIG. 7 is a diagram illustrating processing performed by a filtering unit according to an embodiment of the present disclosure; and

FIG. 8 is a diagram illustrating a specific example of processing performed by the question generation apparatus according to an embodiment of the present disclosure.

### DESCRIPTION OF THE PREFERRED EMBODIMENTS

Hereinafter, embodiments of the present invention will be described with reference to the drawings. Note that the present invention is not limited by these embodiments. In the drawings, the same parts are denoted by the same reference numerals.

It will also be understood that although the terms “first,” “second,” “third,”, and the like may be used in the present disclosure to describe various elements or components, these elements or components should not be limited by these terms. These terms are only used to distinguish one element or component from another element or component. Thus, a first element or component discussed below may also be referred to as a second element or component without departing from the teachings of the inventive concepts.

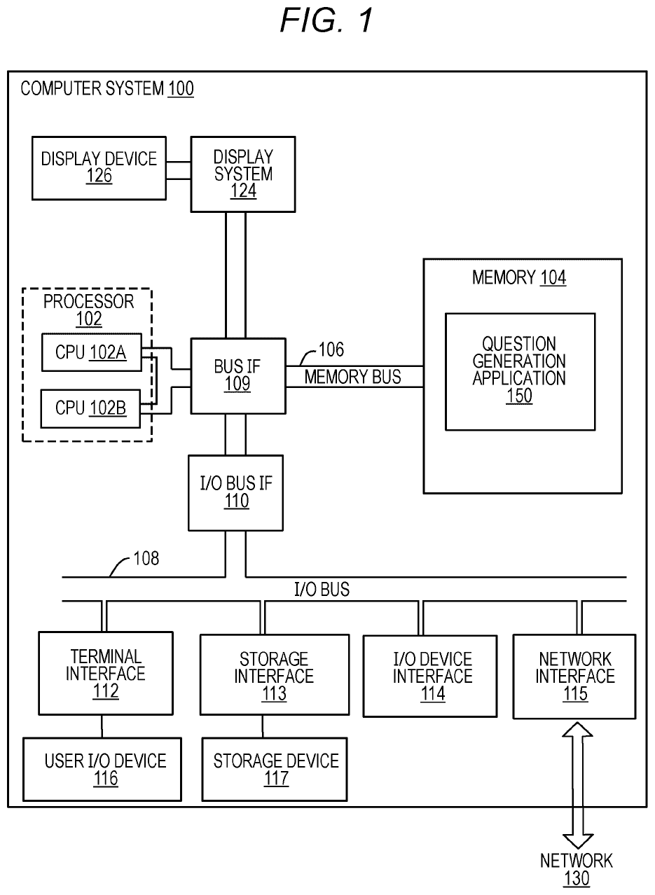

Next, a computer system 100 for implementing embodiments of the present disclosure will be described with reference to FIG. 1. The mechanisms and apparatus of the various embodiments disclosed herein may be applied to any suitable computing system. The main components of the computer system 100 include one or more processors 102, memory 104, a terminal interface 112, a storage interface 113, an input/output (I/O) device interface 114, and a network interface 115. These components may be connected to each other via a memory bus 106, an I/O bus 108, a bus interface unit 109, and an I/O bus interface unit 110.

The computer system 100 may include one or more general purpose programmable central processing units (CPU) 102A and 102B, collectively referred to as processor 102. In a certain embodiment, the computer system 100 may include a plurality of processors, and in another embodiment, the computer system 100 may be a single CPU system. Each processor 102 executes instructions stored in memory 104, and may include an on-board cache. Furthermore, in a certain embodiment, the computer system 100 may include a graphics processing unit (GPU) in addition to the processor 102. By using the GPU, it is possible to speed up processing by a machine learning model or the like used in the question generation application 150 to be described later.

In a certain embodiment, the memory 104 may include a random access semiconductor memory, a storage device, or an (either volatile or non-volatile) storage medium for storing data and programs. The memory 104 may store all or some of the programs, modules, and data structures for implementing the functions described herein. For example, the memory 104 may store a question generation application 150. In a certain embodiment, the question generation application 150 may include instructions or descriptions for performing functions to be described below on the processor 102.

In a certain embodiment, the question generation application 150 may be implemented in hardware via a semiconductor device, a chip, a logic gate, a circuit, a circuit card, and/or another physical hardware device instead of or in addition to a processor-based system. In a certain embodiment, the question generation application 150 may include data other than instructions or descriptions. In a certain embodiment, a camera, a sensor, or another data input device (not shown) may be provided to communicate directly with the bus interface unit 109, the processor 102, or other hardware of the computer system 100.

The computer system 100 may include a bus interface unit 109 that performs communications between the processor 102, the memory 104, the display system 124, and the I/O bus interface unit 110. The I/O bus interface unit 110 may be connected to the I/O bus 108 for transferring data to and from various I/O units. The I/O bus interface unit 110 may communicate with the plurality of I/O interface units 112, 113, 114 and 115, which are also known as I/O processors (IOPs) or I/O adapters (IOAs), via the I/O bus 108.

The display system 124 may include a display controller, a display memory, or both. The display controller may provide video data, audio data, or both to the display device 126. The computer system 100 may also include one or more devices such as sensors configured to collect data and provide the data to the processor 102.

For example, the computer system 100 may include a biometric sensor that collects heart rate data, stress level data, and the like, an environment sensor that collects humidity data, temperature data, pressure data, and the like, a motion sensor that collects acceleration data, motion data, and the like. Other types of sensors can also be used. The display system 124 may be connected to the display device 126 such as a single display screen, a television, a tablet, or a portable device.

The I/O interface unit has a function of communicating with various storage or I/O devices. For example, the terminal interface unit 112 can be provided with a user I/O device 116 such as a user output device, such as a video display device or a speaker television, or a user input device, such as a keyboard, a mouse, a keypad, a touchpad, a trackball, a button, a light pen, or another pointing device. By operating the user input device using a user interface, the user may input input data and instructions to the user I/O device 116 and the computer system 100 and receive output data from the computer system 100. The user interface may be displayed on a display device, reproduced by a speaker, or printed via a printer, for example, via the user I/O device 116.

One or more disk drives or direct access storage devices 117 (which are typically magnetic disk drive storage devices, but may be an array of disk drives or other storage devices configured to appear as a single disk drive) can be attached to the storage interface 113. In a certain embodiment, the storage device 117 may be implemented as any secondary storage device. The contents of the memory 104 may be stored in the storage device 117 and read from the storage device 117 as necessary. The I/O device interface 114 may provide an interface to other I/O devices such as printers and fax machines. The network interface 115 may provide a communication path so that the computer system 100 can communicate with other devices. This communication path may be, for example, a network 130.

In a certain embodiment, the computer system 100 may be a device that receives requests from other computer systems (clients) that do not have a direct user interface, such as a multi-user mainframe computer system, a single-user system, or a server computer. In other embodiments, the computer system 100 may be a desktop computer, a portable computer, a notebook computer, a tablet computer, a pocket computer, a phone, a smartphone, or any other suitable electronic device.

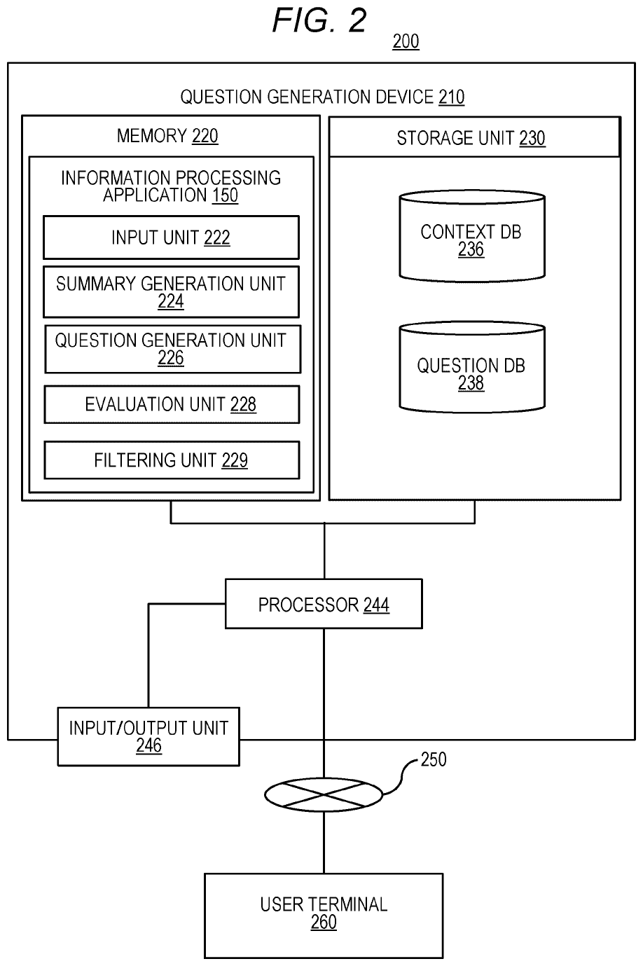

FIG. 2 is a diagram illustrating an example of a configuration of a question generation system 200 according to an embodiment of the present disclosure. The question generation system 200 is a system for generating and outputting multiple-choice questions having a cognitive difficulty level according to a user's demand. As illustrated in FIG. 2, the question generation system 200 mainly includes a question generation apparatus 210, a communication network 250, and a user terminal 260. The question generation apparatus 210 and the user terminal 260 may be connected to each other via the communication network 250.

The question generation apparatus 210 is an apparatus for generating and outputting multiple-choice questions having a cognitive difficulty level according to a user's demand, and mainly includes a memory 220, a storage unit 230, a processor 244, and an input/output unit 246 as illustrated in FIG. 2.

In a certain embodiment, the question generation apparatus 210 may be implemented by the computer system 100 shown in FIG. 1.

The memory 220 may be a memory for storing the question generation application 150 for implementing the functions of the question generation means according to the embodiment of the present disclosure. As illustrated in FIG. 2, the question generation application 150 may include processing instructions for implementing functions of software modules such as an input unit 222, a summary generation unit 224, a question generation unit 226, an evaluation unit 228, and a filtering unit 229.

The input unit 222 is a functional unit for inputting various types of information used by the question generation apparatus 210. In a certain embodiment, the input unit 222 may input context data including text information and difficulty level distribution condition information from the user terminal 260 or the like. The context data here is a passage that is a source from which multiple-choice questions are generated, and may be, for example, a passage extracted from an academic paper, a book, an article, a magazine, or the like, and is not particularly limited as long as it is text information. Furthermore, the difficulty level distribution condition is information that defines a desired ratio between low difficulty level questions and high difficulty level questions in a set of multiple-choice questions to be generated.

The input unit 222 may store the context data and the difficulty level distribution condition to be input in a context DB 236 in the storage unit 230.

Note that the function of the input unit 222 will be described in detail later, and thus description thereof will be omitted here.

The summary generation unit 224 is a functional unit that generates summary information indicating a key point extracted from the context data by processing the context data input by the input unit 222 using a large language model. As will be described later, the generation of high difficulty level questions can be promoted by using the summary information for the context data.

Note that the function of the summary generation unit 224 will be described in detail later, and thus description thereof will be omitted here.

The question generation unit 226 is a functional unit that generates a set of multiple-choice questions (e.g., a first set of multiple-choice questions or a second set of multiple-choice questions) for the context data by processing the context data input by the input unit 222 or the summary information generated by the summary generation unit 224 using the large language model. The question generation unit 226 may store the generated set of multiple-choice questions in a question DB 238 included in the storage unit 230.

Note that the function of the question generation unit 226 will be described in detail later, and thus description thereof will be omitted here.

The evaluation unit 228 is a functional unit that evaluates the set of multiple-choice questions generated by the question generation unit 226 based on a predetermined cognitive difficulty level evaluation criterion to determine difficulty level evaluation values indicating cognitive difficulty levels for the set of multiple-choice questions. Here, the difficulty level evaluation value is information quantitatively indicating a degree of difficulty in specifying a correct choice to the multiple-choice question. In a certain embodiment, the cognitive difficulty level evaluation criterion used to evaluate a difficulty level evaluation value may be, for example, a criterion based on a so-called Bloom classification method. In this case, the difficulty level evaluation value may be expressed as, for example, a numerical value within the range of 0 to 6.

Furthermore, in a certain embodiment, the evaluation unit 228 can input a subset of multiple-choice questions selected by the filtering unit 229 to be described later into the large language model, and determine a performance score quantitatively indicating the performance of the large language model based on a percentage of correct answers with respect to answers of the large language model to the subset of multiple-choice questions. As a result, it is possible to evaluate the performance of the large language model.

Note that the function of the evaluation unit 228 will be described in detail later, and thus description thereof will be omitted here.

The filtering unit 229 is a functional unit that selects a first subset of multiple-choice questions of which difficulty level evaluation values satisfy a predetermined cognitive difficulty level threshold from among the set of multiple-choice questions generated by the question generation unit 226, and outputs the selected first subset of multiple-choice questions. The cognitive difficulty level threshold here may be a value that defines a desired difficulty level, and for example, may be freely set by the user of the user terminal 260.

In a certain embodiment, the filtering unit 229 may generate a subset of multiple-choice questions by excluding multiple-choice questions that do not satisfy the cognitive difficulty level threshold from among the set of multiple-choice questions. When a ratio between low difficulty level questions and high difficulty level questions in the subset of multiple-choice questions satisfies the difficulty level distribution condition input by the input unit 222, the filtering unit 229 may output the subset of multiple-choice questions to the user terminal 260. On the other hand, when a ratio between low difficulty level questions and high difficulty level questions in the subset of multiple-choice questions does not satisfy the difficulty level distribution condition input by the input unit 222, the question generation unit 226 may generate additional multiple-choice questions.

Note that the function of the filtering unit 229 will be described in detail later, and thus description thereof will be omitted here.

The storage unit 230 is a storage area that accommodates a database (hereinafter, “DB”) for storing various types of information according to an embodiment of the present disclosure, and may include a context DB 236 and a question DB 238 as illustrated in FIG. 2.

The context DB 236 is a database for storing input data (context data and difficulty level distribution conditions) used in the present disclosure.

The question DB 238 is a database for storing multiple-choice questions generated by the question generation unit 226.

The processor 244 is a processing unit for implementing a processing instruction that defines a function of each functional unit of the question generation application 150 stored by the memory 220.

The input/output unit 246 is a functional unit that receives information (e.g., context data and difficulty level distribution condition) input to the question generation apparatus 210 and outputs information (such as multiple-choice questions) generated by the question generation apparatus 210. In a certain embodiment, the input/output unit 246 may include, for example, a keyboard, a mouse, a display that displays a graphical user interface (GUI), and the like. In a certain embodiment, the input/output unit 246 may provide the user terminal 260 with a GUI for inputting and outputting various types of information.

The communication network 250 may include, for example, a local area network (LAN), a wide area network (WAN), a satellite network, a cable network, a WiFi network, or any combination thereof.

The user terminal 260 is a terminal device that can be used by the user of the question generation apparatus 210. By using the user terminal 260, the user can input context data and difficulty level distribution condition information to the question generation apparatus 210 and confirm multiple-choice questions output from the question generation apparatus 210. As an example, the user terminal 260 may include, but is not particularly limited to, a smartphone, a smartwatch, a tablet, a personal computer, or the like of a user subscribing to a question generation service provided by the question generation system 200.

Note that, in FIG. 2, for convenience of explanation, a configuration including one user terminal 260 is described as an example, but the number of user terminals 260 is not limited, and a configuration including a plurality of user terminals 260 is also possible.

According to the question generation system 200 of the present disclosure described above, by generating multiple-choice questions having a cognitive difficulty level according to a user's demand, it is possible to more accurately evaluate the understanding of the learner and the performance of the large language model.

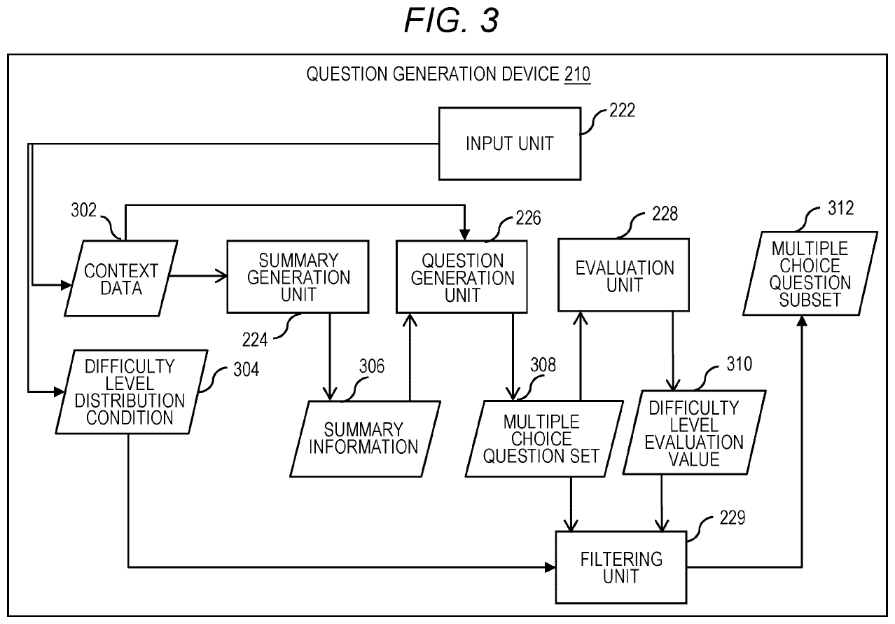

Next, a flow of data in the question generation apparatus 210 according to an embodiment of the present disclosure will be described with reference to FIG. 3.

FIG. 3 is a diagram illustrating a flow of data in the question generation apparatus 210 according to an embodiment of the present disclosure.

First, the input unit 222 acquires context data 302 from the user terminal 260 (not illustrated in FIG. 3). As described above, the context data 302 is a passage that is a source from which multiple-choice questions are generated, and may be, for example, a passage extracted from an academic paper, a book, an article, a magazine, or the like, and is not particularly limited as long as it is text information. Furthermore, the input unit 222 may acquire information on a difficulty level distribution condition 304 from the user terminal 260. The difficulty level distribution condition 304 is information that defines a desired ratio between low difficulty level questions and high difficulty level questions in a set of multiple-choice questions to be generated. For example, in a certain embodiment, this difficulty level distribution condition 304 may be “7:3” as the ratio between low difficulty level questions and high difficulty level questions.

The input unit 222 transfers the acquired context data 302 to the summary generation unit 224 and/or the question generation unit 226, and transfers the acquired difficulty level distribution condition 304 to the filtering unit 229. Furthermore, the input unit 222 may store the context data 302 and the difficulty level distribution condition 304 in the context DB 236 illustrated in FIG. 2.

Next, the summary generation unit 224 generates summary information 306 indicating a key point extracted from the context data 302 by processing the context data 302 received from the input unit 222 using a large language model, and transfers the generated summary information 306 to the question generation unit 226.

Note that, when it is determined that the context data 302 satisfies a predetermined length criterion, the summary generation unit 224 may divide the context data 302 into a plurality of context data sections each having a predetermined length, and generates partial summary information indicating a key point extracted for each of the context data sections by processing each of the context data sections using the large language model.

The length criterion here is a criterion used to specify the context data 302 having a long passage, and may be set to, for example, the number of words (10,000 words or more), the number of characters (30,000 characters or more), the number of pages (20 pages or more), or the like. In this manner, by dividing the long context data 302 into a plurality of sections and generating summary information for each section individually, it is possible to generate questions for requesting understanding of the plurality of sections of the context data 302.

Next, the question generation unit 226 generate a set 308 of multiple-choice questions for the context data and the summary information 306 by processing the context data 302 received from the input unit 222 and the summary information 306 received from the summary generation unit 224 using the large language model.

More specifically, the question generation unit 226 may generate low difficulty level questions for the context data 302 by processing the context data 302 using the large language model, generate high difficulty level questions for the context data 302 by processing the summary information 306 using the large language model, and set the generated low difficulty level questions and high difficulty level questions as the set 308 of multiple-choice questions.

The question generation unit 226 transfers the generated set 308 of multiple-choice questions to the evaluation unit 228 and the filtering unit 229. Furthermore, the question generation unit 226 may store the generated set 308 of multiple-choice questions in the question DB 238 illustrated in FIG. 2.

According to the study of the inventor of the present disclosure, by directly processing the context data 302 using the large language model, it is possible to generate low difficulty level questions such as cloze tasks that can be answered with information extracted directly from the context data 302, but the quality of high difficulty level questions having higher cognitive difficulty levels may be insufficient. On the other hand, the inventor of the present disclosure has found that, when summary information 306 indicating a key point extracted from the context data 302 is generated using the large language model, and then multiple-choice questions for the summary information 306 are generated using the large language model, it is possible to obtain higher quality and higher difficulty level questions that require comprehensive understanding of the context data 302. Therefore, an aspect of the present disclosure relates to generating low difficulty level questions by directly processing context data 302 using the large language model, and generating high difficulty level questions based on summary information 306 indicating a key point extracted from the context data 302.

As a result, it is possible to obtain a set of multiple-choice questions having a difficulty level distribution desired by the user.

Next, the evaluation unit 228 evaluates the set of multiple-choice questions received from the question generation unit 226 based on a predetermined cognitive difficulty level evaluation criterion to determine a difficulty level evaluation value 310 indicating a cognitive difficulty level for the set of multiple-choice questions. Here, the evaluation unit 228 may determine a difficulty level evaluation value 310 for each of the multiple-choice questions included in the set of multiple-choice questions.

As described above, the difficulty level evaluation value 310 here is information quantitatively indicating a degree of difficulty in specifying a correct choice to the multiple-choice question. In a certain embodiment, the cognitive difficulty level evaluation criterion used to evaluate a difficulty level evaluation value may be, for example, a criterion based on a so-called Bloom classification method. In this case, the difficulty level evaluation value may be expressed as, for example, a numerical value within the range of 0 to 6.

Next, the filtering unit 229 selects a subset 312 of multiple-choice questions of which the difficulty level evaluation values 310 received from the evaluation unit 228 satisfy a predetermined cognitive difficulty level threshold from among the set 308 of multiple-choice questions received from the question generation unit 226, and output the selected subset 312 of multiple-choice questions. As described above, the cognitive difficulty level threshold here may be a value that defines a desired difficulty level, and for example, may be freely set by the user of the user terminal 260.

In a certain embodiment, the filtering unit 229 may generate a subset 312 of multiple-choice questions by excluding multiple-choice questions that do not satisfy the cognitive difficulty level threshold from among the set 308 of multiple-choice questions. When a ratio between low difficulty level questions and high difficulty level questions in the subset 312 of multiple-choice questions satisfies the difficulty level distribution condition input by the input unit 222, the filtering unit 229 may output the subset 312 of multiple-choice questions to the user terminal 260. On the other hand, when a ratio between low difficulty level questions and high difficulty level questions in the subset of multiple-choice questions does not satisfy the difficulty level distribution condition input by the input unit 222, the question generation unit 226 may generate additional multiple-choice questions.

In a certain embodiment, after the subset 312 of multiple-choice questions is generated by the filtering unit 229, the evaluation unit 228 may present the subset 312 of multiple-choice questions to a human learner or a large language model, and determine a score that quantitatively indicates the performance of the human learner or the large language model based on a percentage of correct answers to the subset 312 of multiple-choice questions. This score may be the percentage of correct answers to the subset 312 of multiple-choice questions as it is, or may be a value obtained by performing a predetermined calculation on the percentage of correct answers. As a result, it is possible to evaluate the understanding of the human learner and the performance of the large language model.

According to the question generation apparatus 210 of the present disclosure described above, by generating multiple-choice questions having a cognitive difficulty level according to a user's demand, it is possible to more accurately evaluate the understanding of the learner and the performance of the large language model.

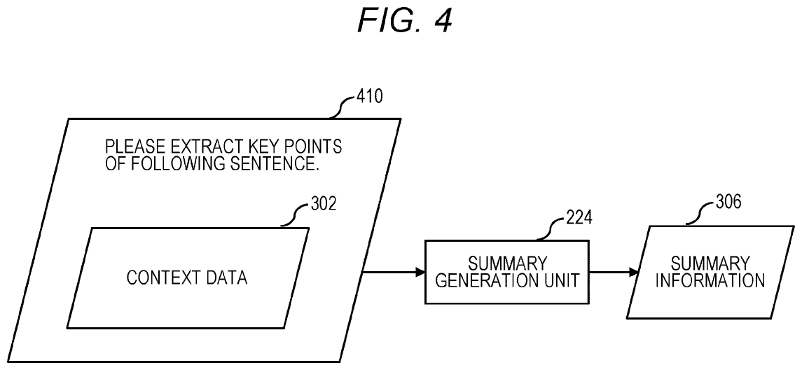

Next, a summary generation unit according to an embodiment of the present disclosure will be described with reference to FIG. 4.

FIG. 4 is a diagram illustrating processing performed by a summary generation unit according to an embodiment of the present disclosure. As described above, the summary generation unit 224 according to an embodiment of the present disclosure is a functional unit for generating summary information 306 indicating a key point extracted from context data 302 by processing the context data 302 using a large language model. FIG. 4 illustrates an example of processing performed by the summary generation unit 224.

As illustrated in FIG. 4, a prompt 410 for requesting generation of summary information 306 for the context data 302 described above is input to the summary generation unit 224. For example, as illustrated in FIG. 4, the prompt 410 may include a passage as the context data 302 and a sentence such as “Please extract the key point of the following passage” for prompting generation of summary information 306 for the passage as the context data 302.

When the prompt 410 illustrated in FIG. 4 is input to the summary generation unit 224, the summary generation unit 224 generates summary information 306 by processing the received prompt 410 using a predetermined large language model. Here, the summary generation unit 224 may use, for example, GPT-4 or the like as the large language model, and the large language model is not particularly limited as long as it is capable of extracting key points of passages.

As an example, in a case where the following is input to the summary generation unit 224 as context data 302: “The cold fusion is a phenomenon in which a nuclear fusion reaction of hydrogen atoms occurs in a low temperature range from room temperature to about 1,000 degrees Celsius. There are a plurality of hypotheses such as a theory that the nuclear fusion reaction occurs due to the tunnel effect and a theory that the nuclear fusion reaction occurs due to the muon included in the cosmic ray. This section deals with nuclear fusion reactions that are visible at low temperatures with the naked eye and are alleged to have occurred on a scale that could be used as a practical energy source. Since the sensational announcement about cold fusion in 1989, the reproducibility of the cold fusion has been low. For this reason, the cold fusion is called “the greatest scientific scandal of the 20th century”, but development to industrial use thereof is expected in accordance with the need for decarbonization in recent years.”, the summary generation unit 224 may generate “There are a plurality of hypotheses about cold fusion in which nuclear fusion reactions of hydrogen atoms occur at low temperatures, and doubts were raised about its reproducibility issue after sensational announcement in 1989. However, in recent years, expectation for industrial use thereof has increased due to the need for decarbonization.” as summary information 306.

As described above, the generation of high difficulty level questions can be promoted by using the summary information 306 obtained by extracting a key point from the context data 302.

In some cases, the passage as the context data 302 may be long. For example, in a case where the context data 302 is a book, an academic paper, or the like, the volume of the context data 302 may exceed hundreds of pages. Therefore, an aspect of a question generation means according to an embodiment of the present disclosure relates to dividing context data 302 having a long passage into fixed-size sections and generating summary information for each section. More specifically, when it is determined that the context data 302 satisfies a predetermined length criterion, the summary generation unit 224 divides the context data 302 into a plurality of context data sections each having a predetermined length and processes each of the context data sections using the large language model, thereby generating partial summary information indicating a key point extracted for each of the context data sections.

The length criterion here is a criterion used to specify context data 302 including a long passage that is desirably divided, and may be set to, for example, the number of words (10,000 words or more), the number of characters (30,000 characters or more), the number of pages (20 pages or more), or the like. In a certain embodiment, the summary generation unit 224 may divide the context data 302 into context data sections each having a predetermined size such as 1000 words, 10,000 characters, 2 pages, or the like, and then individually generate partial summary information that is summary information for each context data section.

In this manner, by dividing the context data 302 having a long passage into fixed-size context data sections and individually generating summary information for each context data section, it is possible to generate a high difficulty level question that requires understanding of a large number of key points included in the context data 302 even in a case where the passage as the context data 302 is long.

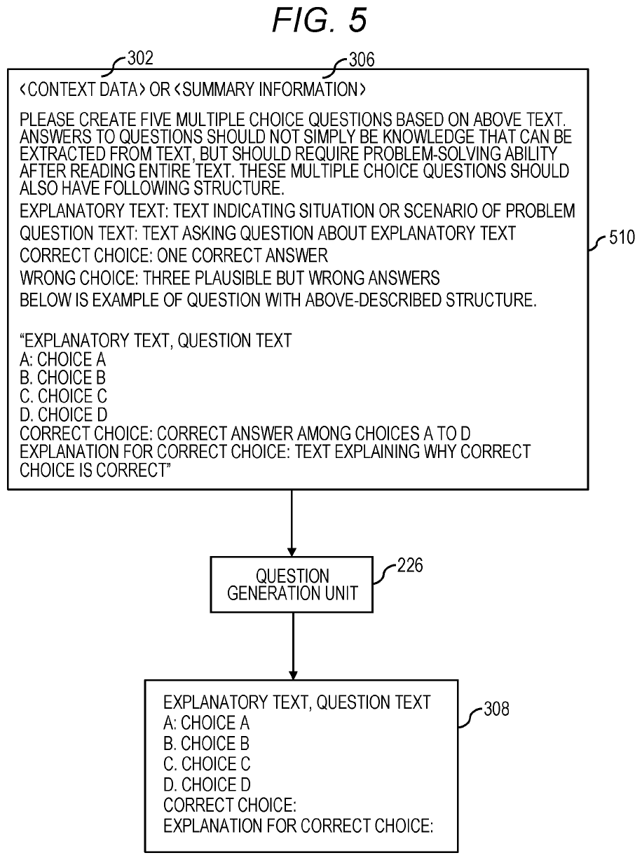

Next, a question generation unit according to an embodiment of the present disclosure will be described with reference to FIG. 5.

FIG. 5 is a diagram illustrating processing performed by the question generation unit 226 according to an embodiment of the present disclosure. As described above, the question generation unit 226 according to an embodiment of the present disclosure is a functional unit for generating a set of multiple-choice questions by processing the context data 302 or the summary information 306 generated from the context data 302 using a large language model. FIG. 5 illustrates an example of processing performed by the question generation unit 226.

As illustrated in FIG. 5, a prompt 510 for requesting generation of multiple-choice questions for the context data 302 or the summary information 306 described above is input to the question generation unit 226. As illustrated in FIG. 5, for example, the prompt 510 may include a passage as the context data 302 or the summary information 306 and a sentence prompting generation of multiple-choice questions for the passage as the context data 302. In a certain embodiment, this prompt 510 may include an example defining a desired structure for the multiple-choice questions. As a result, it is possible to define the structure of the multiple-choice questions generated by the question generation unit 226.

When the prompt 510 illustrated in FIG. 5 is input to the question generation unit 226, the question generation unit 226 generates a set 308 of multiple-choice questions by processing the received prompt 510 using a predetermined large language model. Here, the question generation unit 226 may use, for example, GPT-4 or the like as the large language model, and the large language model is not particularly limited as long as it is capable of generating multiple-choice questions.

Note that the large language model used to generate the set 308 of multiple-choice questions may be the same as or different from the large language model used by the summary generation unit 224 to generate the summary information 306.

The set 308 of multiple-choice questions generated by the question generation unit 226 may be configured in the structure defined in the prompt 510, for example, as illustrated in FIG. 5.

Note that, for convenience of explanation, FIG. 5 illustrates one set 308 of multiple-choice questions including multiple-choice question, but the present disclosure is not limited thereto, and the question generation unit 226 may generate any number of sets 308 of multiple-choice questions including multiple-choice questions.

Furthermore, as described above, when the context data 302 satisfies the length criterion and is divided into a plurality of context data sections by the summary generation unit 224, and partial summary information is generated for each of the context data sections, the question generation unit 226 may generate the set 308 of multiple-choice questions by processing the partial summary information for each of the context data sections using the large language model. As a result, in a case where the passage as the context data 302 is long, it is possible to generate high difficulty level questions that individually require understanding of a large number of key points included in the context data 302.

Furthermore, in a certain embodiment, when the context data 302 satisfies the length criterion and is divided into a plurality of context data sections by the summary generation unit 224, and partial summary information is generated for each of the context data sections, the question generation unit 226 may specify a plurality of context data sections (a first context data section and a second context data section) satisfying a predetermined relevance criterion among the plurality of context data sections, and aggregate partial summary information for the specified context data sections (first partial summary information and second partial summary information) generated for the specified context data sections, thereby generating aggregated partial summary information obtained by combining the partial summary information for the specified context data sections. Thereafter, the question generation unit 226 may generate a set 308 of multiple-choice questions by processing the aggregated partial summary information generated in this manner using the large language model.

The relevance criterion here is a criterion used to specify a plurality of context data sections having similar semantic contents. In a certain embodiment, the plurality of context data sections that satisfy the relevancy criterion may be specified by a natural language processing means, e.g., term frequency-inverse document frequency (TF-IDF), cosine similarity, paragraph vectors, Jaccard similarity, latent semantic analysis, bidirectional encoder representations from transformers (BERT), FastText, semantic textual similarity, siamese networks, or the like.

In this manner, by generating the set 308 of multiple-choice questions from the aggregated partial summary information obtained by aggregating partial summary information for the plurality of context data sections having similar semantic contents, it is possible to generate high difficulty level questions that require comprehensive understanding of a plurality of related topics in the context data 302.

Furthermore, the question generation unit 226 may generate low difficulty level questions obtained by processing the context data 302 using the large language model and high difficulty level questions obtained by processing the summary information 306 obtained by extracting the key point from the context data 302 using the large language model, and set the generated low difficulty level questions and high difficulty level questions as the set 308 of multiple-choice questions.

As a result, it is possible to obtain a set of multiple-choice questions having a difficulty level distribution desired by the user.

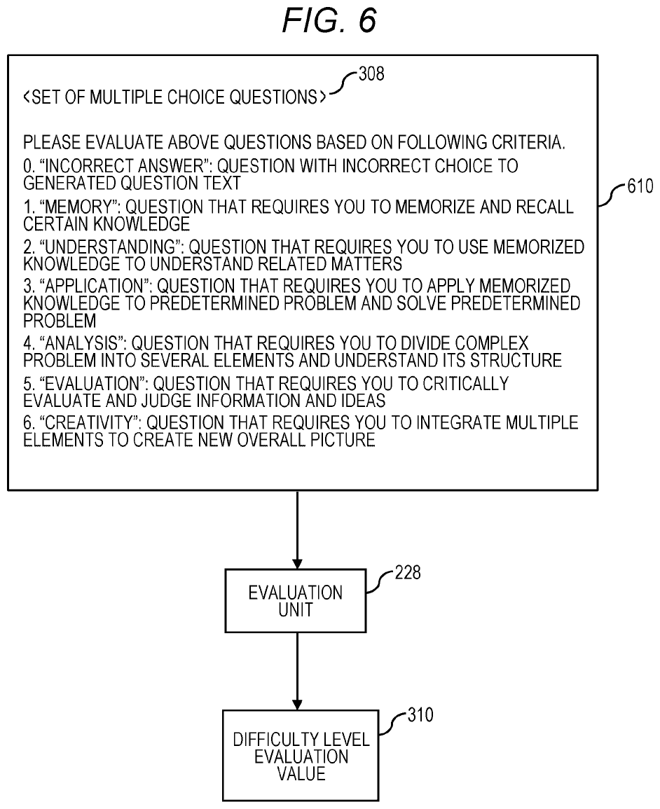

Next, an evaluation unit according to an embodiment of the present disclosure will be described with reference to FIG. 6.

FIG. 6 is a diagram illustrating processing performed by the evaluation unit 228 according to an embodiment of the present disclosure. As described above, the evaluation unit 228 according to an embodiment of the present disclosure is a functional unit that evaluates the set 308 of multiple-choice questions generated by the question generation unit 226 described with reference to FIG. 5 based on a predetermined cognitive difficulty level evaluation criterion to determine difficulty level evaluation values indicating cognitive difficulty levels for the set of multiple-choice questions. FIG. 6 illustrates an example of processing performed by the evaluation unit 228.

As illustrated in FIG. 6, a prompt 610 for requesting evaluation for the set 308 of multiple-choice questions generated by the question generation unit 226 is input to the evaluation unit 228. As illustrated in FIG. 6, for example, the prompt 610 may include a set 308 of multiple-choice questions and a passage defining a cognitive difficulty level evaluation criterion used in evaluating the set 308 of multiple-choice questions.

The cognitive difficulty level evaluation criterion here is a criterion used to evaluate a cognitive difficulty level of the set 308 of multiple-choice questions, and may be an evaluation criterion based on a so-called Bloom classification method. More specifically, the cognitive difficulty level evaluation criterion may give the following definitions:
“0” as a difficulty level evaluation value for a question for which a correct choice is wrong with respect to the question text;
“1” as a difficulty level evaluation value for a question that requires memorizing and recalling certain knowledge;
“2” as a difficulty level evaluation value for a question that requires interpreting memorized knowledge;
“3” as a difficulty level evaluation value for a question that requires applying memorized knowledge to a predetermined issue and solving the predetermined issue;
“4” as a difficulty level evaluation value for a question that requires dividing a complex issue into several elements and understanding its structure;
“5” as a difficulty level evaluation value for a question that requires critically evaluating and judging information and ideas; and
“6” as a difficulty level evaluation value for a question that requires integrating a plurality of elements and creating a new overall picture.

When the prompt 610 illustrated in FIG. 6 is input to the evaluation unit 228, the evaluation unit 228 evaluates the set 308 of multiple-choice questions based on the defined cognitive difficulty level evaluation criterion by processing the received prompt 610 using a predetermined large language model, and generates a difficulty level evaluation value 310 indicating a cognitive difficulty level for the set 308 of multiple-choice questions. As described above, the difficulty level evaluation value 310 is information that expresses the cognitive difficulty level of each question included in the set 308 of multiple-choice questions as a numerical value in the range of “0 to 6” defined in the cognitive difficulty level evaluation criterion.

In this manner, by evaluating the cognitive difficulty level of the set 308 of multiple-choice questions using the above-described cognitive difficulty level evaluation criterion, it is possible to quantitatively grasp the cognitive ability required to solve the question as compared with evaluation using a conventional evaluation criterion such as a difficulty level of vocabulary and the number of choices. Furthermore, as will be described later, by filtering the set 308 of multiple-choice questions to which the cognitive difficulty level is assigned in this manner, it is possible to specify a subset of multiple-choice questions capable of more accurately evaluating the understanding of the learner and the performance of the large language model.

Furthermore, in a certain embodiment, after the subset 312 of multiple-choice questions is generated by the filtering unit 229, the evaluation unit 228 may present the subset 312 of multiple-choice questions to a human learner or a large language model, and determine a score that quantitatively indicates the performance of the human learner or the large language model based on a percentage of correct answers to the subset 312 of multiple-choice questions. This score may be the percentage of correct answers to the subset 312 of multiple-choice questions as it is, or may be a value obtained by performing a predetermined calculation on the percentage of correct answers. As a result, it is possible to evaluate the understanding of the human learner and the performance of the large language model.

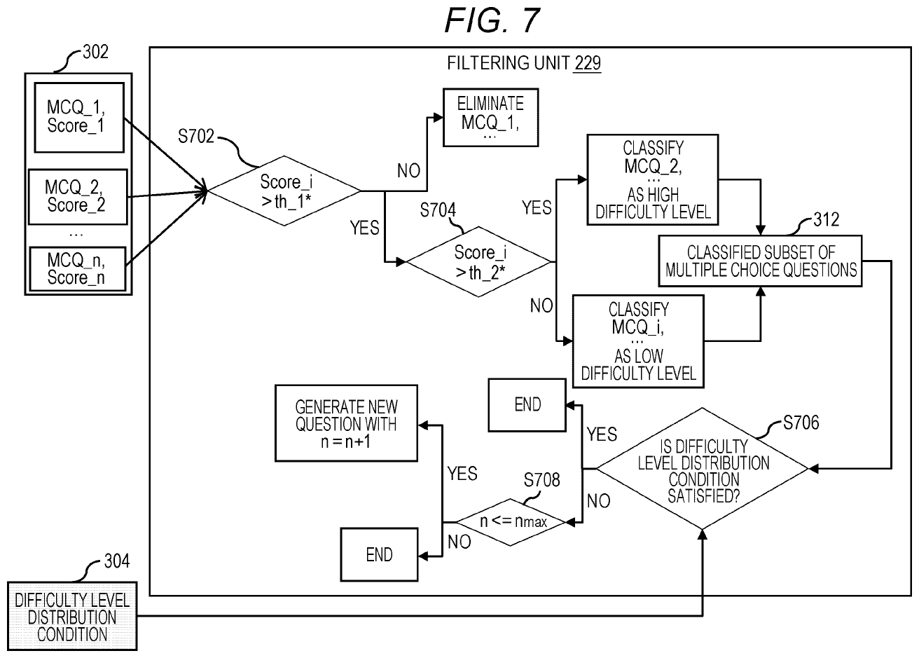

Next, a filtering unit according to an embodiment of the present disclosure will be described with reference to FIG. 7.

FIG. 7 is a diagram illustrating processing performed by the filtering unit 229 according to an embodiment of the present disclosure. As described above, the filtering unit 229 according to an embodiment of the present disclosure is a functional unit that selects a subset of multiple-choice questions of which difficulty level evaluation values satisfy a predetermined cognitive difficulty level threshold from among the set 308 of multiple-choice questions generated by the question generation unit 226 described with reference to FIG. 5, and outputs the selected subset of multiple-choice questions. FIG. 7 illustrates an example of processing performed by the filtering unit 229.

First, as illustrated in FIG. 7, in step S702, the filtering unit 229 determines whether difficulty level evaluation values (Score_1, Score_2, . . . , and Score_n) assigned to multiple-choice questions (MCQ 1, MCQ_2, . . . , and MCQ_n) included in a set 302 of multiple-choice questions satisfy a first cognitive difficulty level threshold. The first cognitive difficulty level threshold here is a threshold for specifying low-quality multiple-choice questions, and may be set to, for example, “difficulty level evaluation value: 1 or more”. As a result, it is possible to eliminate low-quality questions for which correct choices are wrong with respect to question text from the set 302 of multiple-choice questions.

The filtering unit 229 generates a subset of multiple-choice questions by excluding the multiple-choice questions that do not satisfy the first cognitive difficulty level threshold from the set 302 of multiple-choice questions.

Next, in step S704, the filtering unit 229 classifies multiple-choice questions that satisfy a second cognitive difficulty level threshold and classifies multiple-choice questions that do not satisfy the second cognitive difficulty level threshold as low difficulty level questions, among the subset of multiple-choice questions generated in step S702 as high difficulty level questions, thereby generating a subset 312 of classified multiple-choice questions. Here, the second cognitive difficulty level threshold is a threshold for sorting low difficulty level questions that can be relatively easily answered and high difficulty level questions that are more difficult to answer, and may be set to, for example, “difficulty level evaluation value: 4 or more”. Note that the second cognitive difficulty level threshold may be freely set, for example, by the user of the question generation apparatus 210. As a result, it is possible to provide multiple-choice questions having a cognitive difficulty level according to a user's demand.

Next, in step S706, the filtering unit 229 determines whether the subset 312 of multiple-choice questions classified in the subset of multiple-choice questions satisfies the difficulty level distribution condition 304 based on the classified questions generated in step S704 and the difficulty level distribution condition 304 input from the user to the input unit 222. As described above, the difficulty level distribution condition 304 here is information that defines a desired ratio between low difficulty level questions and high difficulty level questions, and for example, may be “7:3” as the ratio between low difficulty level questions and high difficulty level questions.

As an example, in a case where the difficulty level distribution condition 304 is “7:3”, and the subset 312 of classified multiple-choice questions includes eight low difficulty level questions and includes two high difficulty level questions, the filtering unit 229 determines that the difficulty level distribution condition 304 is not satisfied because the number of high difficulty level questions is insufficient. On the other hand, in a case where the difficulty level distribution condition 304 is “7:3”, and the subset 312 of classified multiple-choice questions includes seven low difficulty level questions and three high difficulty level questions, the filtering unit 229 determines that the difficulty level distribution condition 304 is satisfied.

When the subset 312 of classified multiple-choice questions satisfies the difficulty level distribution condition 304, the subset of multiple-choice questions is output to the user and the processing ends. On the other hand, when the subset 312 of multiple-choice questions does not satisfy the difficulty level distribution condition 304, this processing proceeds to step S708.

In step S708, the filtering unit 229 determines whether the counter variable n indicating the number of times the processing in steps S702 to S706 has been performed on the subset of multiple-choice questions is equal to or smaller than a threshold nₘₐₓ for the number of times that defines the upper limit number of times of processing. The threshold nₘₐₓ for the number of times here is a value that defines the number of times the question generation processing may be repeated in order to satisfy the difficulty level distribution condition 304, and may be set by the user. As an example, the threshold nₘₐₓ for the number of times may be “5”. In principle, the higher the threshold nₘₐₓ for the number of times, the more likely it is to obtain a subset of multiple-choice questions that satisfies the difficulty level distribution condition 304, but more computing resources are required.

When the counter variable n indicating the number of times the processing in steps S702 to S706 has been performed on the subset of multiple-choice questions is equal to or smaller than the threshold nₘₐₓ for the number of times that defines the upper limit number of times of processing, the counter variable n increments (n=n+1), the question generation unit 226 (not illustrated in FIG. 7) generates a set of additional multiple-choice questions (a second set of multiple-choice questions) for the context data or the summary information, and the evaluation unit 228 determines a difficulty level evaluation value, and then the processing in steps S702 to S706 described above is repeated on the set of additional multiple-choice questions. Subsequently, when a subset of multiple-choice questions (that is, a set of multiple-choice questions including the first subset of multiple-choice questions and the second subset of multiple-choice questions) satisfies the difficulty level distribution condition 304, these multiple-choice questions are output.

On the other hand, when the counter variable n indicating the number of times the processing in steps S702 to S706 has been performed on the subset of multiple-choice questions is equal to or larger than the threshold nₘₐₓ for the number of times that defines the upper limit number of times of processing, this processing ends, and a notification indicating that a set of multiple-choice questions satisfying the difficulty level distribution condition 304 has not been generated is output to the user. In this case, the generated multiple-choice questions may be output together.

According to the processing performed by the filtering unit 229 described above, low-quality multiple-choice questions are excluded from among the set 302 of multiple-choice questions to which difficulty level evaluation values are assigned, and the generation of questions is repeated until the difficulty level distribution condition designated by the user is satisfied, making it possible to generate and provide multiple-choice questions having a cognitive difficulty level according to a user's demand.

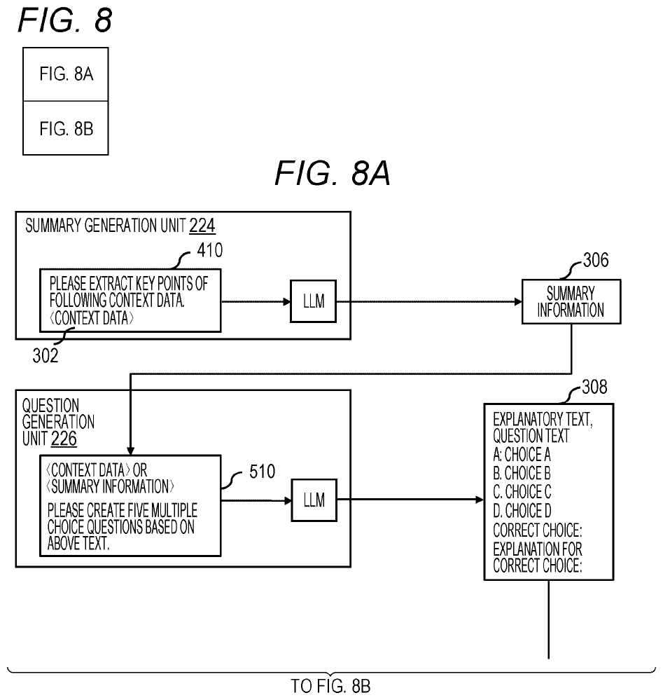

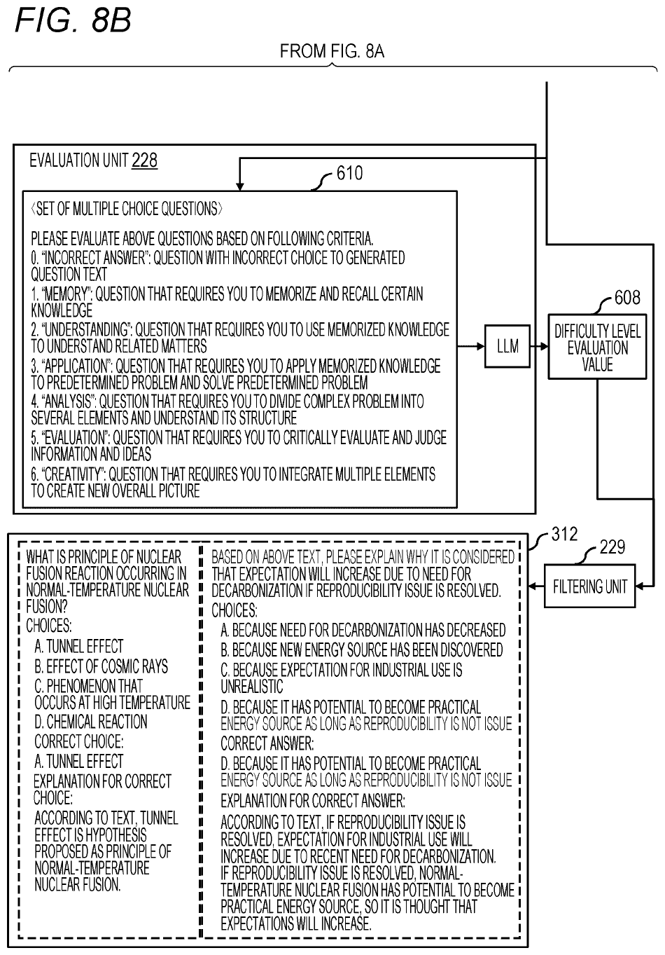

Next, a specific example of processing performed by a question generation apparatus according to an embodiment of the present disclosure will be described with reference to FIG. 8.

FIG. 8 is a diagram illustrating a specific example of processing performed by a question generation apparatus according to an embodiment of the present disclosure.

First, by generating a prompt 410 for requesting extraction of a key point of the following context data 302 from the input unit 222 (not illustrated in FIG. 8) and processing the context data 302 using the large language model: “The cold fusion is a phenomenon in which a nuclear fusion reaction of hydrogen atoms occurs in a low temperature range from room temperature to about 1,000 degrees Celsius. There are a plurality of hypotheses such as a theory that the nuclear fusion reaction occurs due to the tunnel effect and a theory that the nuclear fusion reaction occurs due to the muon included in the cosmic ray. This section deals with nuclear fusion reactions that are visible at low temperatures with the naked eye and are alleged to have occurred on a scale that could be used as a practical energy source. Since the sensational announcement about cold fusion in 1989, the reproducibility of the cold fusion has been low. For this, reason, the cold fusion is called “the greatest scientific scandal of the 20th century”, but development to industrial use thereof is expected in accordance with the need for decarbonization in recent years.”, the summary generation unit 224 generates the following summary information 306: “There are a plurality of hypotheses about cold fusion in which nuclear fusion reactions of hydrogen atoms occur at low temperatures, and doubts were raised about its reproducibility issue after sensational announcement in 1989. However, in recent years, expectation for industrial use thereof has increased due to the need for decarbonization.”

Next, by processing a prompt 510 for requesting generation of questions for the context data 302 and the summary information 306 using the large language model, the question generation unit 226 generates a set 308 of multiple-choice questions. More specifically, the question generation unit 226 generates the following question as a low difficulty level questions by processing a prompt for requesting generation of questions for the context data 302 using the large language model.

“Question 1. What is stated about the principle by which a nuclear fusion reaction occurs in cold fusion?

### Choices:

A. Tunnel effect
B. Influence of cosmic rays
C. Phenomenon that occurs at a high temperature
D. Chemical reaction

### Correct Choice:

A. Tunnel effect

### Explanation for Correct Choice:

According to the passage, the tunnel effect is a hypothesis proposed as the principle of cold fusion.”

Furthermore, the question generation unit 226 generates the following question as a high difficulty level question by processing a prompt for requesting generation of questions for the summary information 306 using the large language model.

“Question 2. Based on the above passage, please explain why it is considered that the expectation will increase from the need for decarbonization if the reproducibility issue is solved.

### Choices:

A. Because the need for decarbonization has decreased
B. Because a new energy source has been found
C. Because expectation for industrial use is unrealistic
D. Because it has potential to become a practical energy source as long as reproducibility is not an issue

### Correct Choice:

D. Because it has potential to become a practical energy source as long as reproducibility is not an issue

### Explanation for Correct Choice:

According to the passage, if the reproducibility issue is solved, the expectation for industrial use will increase because of the recent need for decarbonization. If the reproducibility issue is eliminated, the cold fusion has potential to become a practical energy source, so it is thought that the expectation will increase.”

Next, by generating a prompt 610 for requesting evaluation for the set 302 of multiple-choice questions received from the question generation unit 226 and processing the prompt 610 using the large language model, the evaluation unit 228 generates information on a difficulty level evaluation value 310 indicating a cognitive difficulty level of each of the multiple-choice questions included in the set 308 of multiple-choice questions. As an example, the evaluation unit 228 may determine “1” as a difficulty level evaluation value for Question 1 above and determine “3” as a difficulty level evaluation value for Question 2 above.

Note that, in this case, the large language model may output information indicating why a specific difficulty level evaluation value 310 has been determined for a specific question. For example, for Question 2 above, the large language model may out the following explanatory text: “This question requires understanding the given information and inferring what influence there would be if the reproducibility issue were solved. At the stage of application, a skill is required to apply memorized knowledge to new situations.”

Next, the filtering unit 229 performs the filtering processing described above with reference to FIG. 7 based on the difficulty level evaluation values 310 (Score 1, Score_2, . . . , and Score_n) assigned to the respective multiple-choice questions (MCQ_1, MCQ_2, . . . , and MCQ_n) included in the set 302 of multiple-choice questions, selects a subset of multiple-choice questions of which the difficulty level evaluation values satisfy a predetermined cognitive difficulty level threshold from among the set 302 of multiple-choice questions, and output the selected subset of multiple-choice questions. For example, the filtering unit 229 may output Question 1 above and Question 2 above as a subset of multiple-choice questions, assuming that they satisfy the cognitive difficulty level threshold.

According to the question generation apparatus 210 described above, by generating multiple-choice questions having a cognitive difficulty level according to a user's demand, it is possible to more accurately evaluate the understanding of the learner and the performance of the large language model.

As described above, an aspect of a question generation means according to an embodiment of the present disclosure relates to generating multiple-choice questions having a cognitive difficulty level according to a user's demand. By processing context data using the large language model, it is possible to generate low difficulty level questions for the context data, and by processing summary information obtained by extracting a key point of the context data using the large language model, it is possible to generate high difficulty level questions for the context data.

In a case where the generation of multiple-choice questions for the summary information indicating the key point extracted from the context data is performed by the large language model, it is possible to obtain high difficulty level questions having a higher cognitive difficulty level, which requires comprehensive understanding of the context data, as compared with those obtained in a case where the context data is directly input to the large language model.

Furthermore, in a case where the context data includes a long passage (for example, in a case where the context data satisfies a length criterion such as 10 pages or more and 30,000 characters or more), the summary generation unit according to the embodiment of the present disclosure may divide the context data into a plurality of context data sections each having a predetermined length and generate partial summary information indicating a key point extracted for each of the context data sections by processing each of the context data sections using the large language model. Thereafter, the question generation unit may generate a multiple-choice question by processing the partial summary information for each of the context data sections using the large language model.

Here, the question generation unit may generate a multiple-choice question by processing the partial summary information for each of the context data sections individually, or may generate a multiple-choice question by aggregating the partial summary information for the plurality of context data sections. By processing the partial summary information for each of the context data sections individually to generate a multiple-choice question, it is possible to generate high difficulty level questions that individually requires understanding of a large number of topics included in the context data. On the other hand, by aggregating the partial summary information for the plurality of context data sections (for example, partial summary information of context data that satisfies a predetermined relevance criterion) to generate a multiple-choice question, it is possible to generate a high difficulty level question that requires comprehensive understanding of a plurality of related topics.

Furthermore, by evaluating multiple-choice questions generated by the question generation unit based on a predetermined cognitive difficulty level evaluation criterion using the evaluation unit according to the embodiment of the present disclosure and selecting multiple-choice questions that satisfy a predetermined cognitive difficulty level threshold using the filtering unit according to the embodiment of the present disclosure, it is possible to obtain a subset of multiple-choice questions having an appropriate balance between low difficulty level questions and high difficulty level questions that satisfies the difficulty level distribution condition defined by the user. By presenting the multiple-choice questions obtained as described above to a human learner or a large language model, it is possible to evaluate the understanding of the human learner and the performance of the large language model.

According to the question generation means according to the embodiment of the present disclosure described above, it is possible to provide the question generation means capable of more accurately evaluating the understanding of the learner and the performance of the large language model.

As described above, the question generation means according to the embodiment of the present disclosure relates to the following aspects.

### (Aspect 1)

A question generation apparatus, including:
a processor and a memory,
in which the memory includes processing instructions for causing the processor to function as:
an input unit that acquires context data including text information;
a question generation unit that generates a first set of multiple-choice questions for the context data by processing the context data using a first large language model;
an evaluation unit that determines difficulty level evaluation values indicating cognitive difficulty levels for the first set of multiple-choice questions by evaluating the first set of multiple-choice questions based on a predetermined cognitive difficulty level evaluation criterion; and
a filtering unit that selects a first subset of multiple-choice questions of which the difficulty level evaluation values satisfy a predetermined cognitive difficulty level threshold from among the first set of multiple-choice questions, and outputs the selected first subset of multiple-choice questions.

### (Aspect 2)

The question generation apparatus according to aspect 1, in which
the input unit acquires, in addition to the context data, a difficulty level distribution condition that defines a ratio between low difficulty level questions of which the difficulty level evaluation values satisfy a first cognitive difficulty level threshold in the first set of multiple-choice questions and high difficulty level questions of which the difficulty level evaluation values satisfy a second cognitive difficulty level threshold in the first set of multiple-choice questions.

### (Aspect 3)

The question generation apparatus according to aspect 2, in which
the memory further includes processing instructions for causing the processor to function as a summary generation unit that generates summary information indicating a key point extracted from the context data by processing the context data using a second large language model.

### (Aspect 4)

The question generation apparatus according to aspect 3, in which
the question generation unit generates the low difficulty level questions for the context data by processing the context data using the first large language model, and generates the high difficulty level questions for the context data by processing the summary information using the first large language model.

### (Aspect 5)

The question generation apparatus according to aspect 4, in which
the filtering unit generates the first subset of multiple-choice questions by eliminating multiple-choice questions that do not satisfy the first cognitive difficulty level threshold from the first set of multiple-choice questions, determines whether a ratio between low difficulty level questions and high difficulty level questions included in the first subset of multiple-choice questions satisfies the difficulty level distribution condition, and outputs the first subset of multiple-choice questions when the ratio between low difficulty level questions and high difficulty level questions included in the first subset of multiple-choice questions satisfies the difficulty level distribution condition,
when the ratio between low difficulty level questions and high difficulty level questions included in the first subset of multiple-choice questions does not satisfy the difficulty level distribution condition,
the question generation unit generates a second set of multiple-choice questions for the context data by processing the context data or the summary information using the first large language model, and
the filtering unit generates a second subset of multiple-choice questions by eliminating multiple-choice questions that do not satisfy the first cognitive difficulty level threshold from the second set of multiple-choice questions, determines whether a ratio between low difficulty level questions and high difficulty level questions included in the first subset of multiple-choice questions and the second subset of multiple-choice questions satisfies the difficulty level distribution condition, and outputs the first subset of multiple-choice questions and the second subset of multiple-choice questions when the ratio between low difficulty level questions and high difficulty level questions included in the first subset of multiple-choice questions and the second subset of multiple-choice questions satisfies the difficulty level distribution condition.

### (Aspect 6)

The question generation apparatus according to aspect 4 or 5, in which
when it is determined that the context data satisfies a predetermined length criterion, the summary generation unit divides the context data into a plurality of context data sections each having a predetermined length, and generates partial summary information indicating a key point extracted for each of the context data sections by processing each of the context data sections using the second large language model, and
the question generation unit specifies a first context data section and a second context data section that satisfy a predetermined relevance criterion among the plurality of context data sections, and generates the high difficulty level questions for the context data by processing aggregated partial summary information obtained by aggregating first partial summary information indicating a key point extracted from the specified first context data section and second partial summary information indicating a key point extracted from the specified second context data section using the first large language model.

### (Aspect 7)

The question generation apparatus according to any one of aspects 1 to 6, in which
the evaluation unit inputs the first subset of multiple-choice questions into a third large language model, and determines a performance score that quantitatively indicates performance of the third large language model based on a percentage of correct answers with respect to answers of the third large language model to the first subset of multiple-choice questions.

### (Aspect 8)

The question generation apparatus according to any one of aspects 1 to 7, in which
for each of the questions included in the first set of multiple-choice questions, the evaluation unit determines a first difficulty level evaluation value for a question for which a correct choice is wrong with respect to question text, determines a second difficulty level evaluation value for a question that requires memorizing and recalling certain knowledge, determines a third difficulty level evaluation value for a question that requires interpreting memorized knowledge, determines a fourth difficulty level evaluation value for a question that requires applying memorized knowledge to a predetermined issue and solving the predetermined issue, determines a fifth difficulty level evaluation value for a question that requires dividing a complex issue into several elements and understanding a structure thereof, determines a sixth difficulty level evaluation value for a question that requires critically evaluating and judging information and ideas, and determines a seventh difficulty level evaluation value for a question that requires integrating a plurality of elements and creating a new overall picture.

Although the embodiments of the present invention have been described above, the present invention is not limited to the above-described embodiments, and various modifications can be made without departing from the gist of the present invention.

What is claimed is:

1. A question generation apparatus, comprising:
a processor and a memory,
wherein the memory includes processing instructions for causing the processor to function as:
an input unit that acquires context data including text information;
a question generation unit that generates a first set of multiple-choice questions for the context data by processing the context data using a first large language model;
an evaluation unit that determines difficulty level evaluation values indicating cognitive difficulty levels for the first set of multiple-choice questions by evaluating the first set of multiple-choice questions based on a predetermined cognitive difficulty level evaluation criterion; and
a filtering unit that selects a first subset of multiple-choice questions of which the difficulty level evaluation values satisfy a predetermined cognitive difficulty level threshold from among the first set of multiple-choice questions, and outputs the selected first subset of multiple-choice questions.

2. The question generation apparatus according to claim 1, wherein
the input unit acquires, in addition to the context data, a difficulty level distribution condition that defines a ratio between low difficulty level questions of which the difficulty level evaluation values satisfy a first cognitive difficulty level threshold in the first set of multiple-choice questions and high difficulty level questions of which the difficulty level evaluation values satisfy a second cognitive difficulty level threshold in the first set of multiple-choice questions.

3. The question generation apparatus according to claim 2, wherein
the memory further includes processing instructions for causing the processor to function as a summary generation unit that generates summary information indicating a key point extracted from the context data by processing the context data using a second large language model.

4. The question generation apparatus according to claim 3, wherein
the question generation unit generates the low difficulty level questions for the context data by processing the context data using the first large language model, and generates the high difficulty level questions for the context data by processing the summary information using the first large language model.

5. The question generation apparatus according to claim 4, wherein
the filtering unit generates the first subset of multiple-choice questions by eliminating multiple-choice questions that do not satisfy the first cognitive difficulty level threshold from the first set of multiple-choice questions, determines whether a ratio between low difficulty level questions and high difficulty level questions included in the first subset of multiple-choice questions satisfies the difficulty level distribution condition, and outputs the first subset of multiple-choice questions when the ratio between low difficulty level questions and high difficulty level questions included in the first subset of multiple-choice questions satisfies the difficulty level distribution condition,
when the ratio between low difficulty level questions and high difficulty level questions included in the first subset of multiple-choice questions does not satisfy the difficulty level distribution condition,
the question generation unit generates a second set of multiple-choice questions for the context data by processing the context data or the summary information using the first large language model, and
the filtering unit generates a second subset of multiple-choice questions by eliminating multiple-choice questions that do not satisfy the first cognitive difficulty level threshold from the second set of multiple-choice questions, determines whether a ratio between low difficulty level questions and high difficulty level questions included in the first subset of multiple-choice questions and the second subset of multiple-choice questions satisfies the difficulty level distribution condition, and outputs the first subset of multiple-choice questions and the second subset of multiple-choice questions when the ratio between low difficulty level questions and high difficulty level questions included in the first subset of multiple-choice questions and the second subset of multiple-choice questions satisfies the difficulty level distribution condition.

6. The question generation apparatus according to claim 4, wherein
when it is determined that the context data satisfies a predetermined length criterion, the summary generation unit divides the context data into a plurality of context data sections each having a predetermined length, and generates partial summary information indicating a key point extracted for each of the context data sections by processing each of the context data sections using the second large language model, and
the question generation unit specifies a first context data section and a second context data section that satisfy a predetermined relevance criterion among the plurality of context data sections, and generates the high difficulty level questions for the context data by processing aggregated partial summary information obtained by aggregating first partial summary information indicating a key point extracted from the specified first context data section and second partial summary information indicating a key point extracted from the specified second context data section using the first large language model.

7. The question generation apparatus according to claim 1, wherein
the evaluation unit inputs the first subset of multiple-choice questions into a third large language model, and determines a performance score that quantitatively indicates performance of the third large language model based on a percentage of correct answers with respect to answers of the third large language model to the first subset of multiple-choice questions.

8. The question generation apparatus according to claim 1, wherein
for each of the questions included in the first set of multiple-choice questions, the evaluation unit determines a first difficulty level evaluation value for a question for which is a correct choice is wrong with respect to question text, determines a second difficulty level evaluation value for a question that requires memorizing and recalling certain knowledge, determines a third difficulty level evaluation value for a question that requires interpreting memorized knowledge, determines a fourth difficulty level evaluation value for a question that requires applying memorized knowledge to a predetermined issue and solving the predetermined issue, determines a fifth difficulty level evaluation value for a question that requires dividing a complex issue into several elements and understanding a structure thereof, determines a sixth difficulty level evaluation value for a question that requires critically evaluating and judging information and ideas, and determines a seventh difficulty level evaluation value for a question that requires integrating a plurality of elements and creating a new overall picture.

9. A question generation method performed in a question generation apparatus including a processor and a memory, the question generation method comprising:
by processing instructions stored in the memory,
acquiring context data including text information;
generating a first set of multiple-choice questions for the context data by processing the context data using a first large language model;
determining difficulty level evaluation values indicating cognitive difficulty levels for the first set of multiple-choice questions by evaluating the first set of multiple-choice questions based on a predetermined cognitive difficulty level evaluation criterion; and
selecting a first subset of multiple-choice questions of which the difficulty level evaluation values satisfy a predetermined cognitive difficulty level threshold from among the first set of multiple-choice questions, and outputting the selected first subset of multiple-choice questions.

10. A question generation system to which a question generation apparatus and a user terminal are connected via a communication network, the question generation apparatus including a processor and a memory,
wherein the memory includes processing instructions for causing the processor to function as:
an input unit that acquires context data including text information from the user terminal;
a question generation unit that generates a first set of multiple-choice questions for the context data by processing the context data using a first large language model;
an evaluation unit that determines difficulty level evaluation values indicating cognitive difficulty levels for the first set of multiple-choice questions by evaluating the first set of multiple-choice questions based on a predetermined cognitive difficulty level evaluation criterion; and
a filtering unit that selects a first subset of multiple-choice questions of which the difficulty level evaluation values satisfy a predetermined cognitive difficulty level threshold from among the first set of multiple-choice questions, and outputs the selected first subset of multiple-choice questions to the user terminal.
